(19) United States
(12) Patent Application Publication
(10) Pub. No.: US 2023/0047013 A1
(43) Pub. Date: Feb. 16, 2023

(54) SYSTEM AND METHOD FOR ARTIFICIAL INTELLIGENCE (AI)-BASED PROTOCOL COMPLIANCE TRACKING FOR WORKPLACE APPLICATIONS

(71) Applicant: Cherry Labs, Inc., Wilmington, DE (US)

(72) Inventors: Maksim Goncharov, Redwood City, CA (US); Margarita Goncharova, Redwood City, CA (US); Jiunn Benjamin Heng, Los Altos Hills, CA (US)

(21) Appl. No.: 17/478,514

(22) Filed: Sep. 17, 2021

Related U.S. Application Data
(60) Provisional application No. 63/232,894, filed on Aug. 13, 2021.

(51) Int. Cl. G06Q 10/06; G06K 9/00

(52) U.S. Cl. CPC G06Q 10/06398; G06Q 10/06393; G06Q 10/063114; G06K 9/00335

(57) ABSTRACT

A new approach is proposed that supports protocol compliance by a person in various workplace applications and environments. The proposed approach determines if a person is following a set of protocols/procedures created and defined to ensure safety and efficiency of the workers/employees in his/her workplace environment. This proposed approach focuses on specifying one or more zones of interest, identifying presence of the person and/or an object associated with the person in the one or more zones of interest, classifying a sequence of activities and/or postures of the person, and determining the durations of the activities. A is notified if it is determined that the person is not in compliance with the set of protocols in the workplace environment. In addition, data collected from the one or more zones of interest is stored securely in a local site to protect confidentiality of production processes as well as privacy of the person.

### CROSS-REFERENCE TO RELATED APPLICATIONS

This application claims the benefit of U.S. Provisional Patent Application No. 63/232,894, filed Aug. 13, 2021, which is incorporated herein in its entirety by reference.

This application is related to co-pending United States patent application No. ______, filed ______, and entitled “SYSTEM AND METHOD FOR ARTIFICIAL INTELLIGENCE (AI)-BASED ACTIVITY TRACKING FOR PROTOCOL COMPLIANCE,” which is incorporated herein in its entirety by reference.

### BACKGROUND

A variety of security, monitoring, and control systems equipped with a plurality of cameras, audio input devices, and/or sensors have been used to detect certain human presence or a particular human activity at a monitored location, specifically in a home/living environment. In many cases, a snapshot of an event or activity happened at the monitored location is collected by the devices/sensors to piece together if this occurrence is part of the normal trend or is an abnormal event. However, there is often no context or feedback loop on whether a sequence of activities has occurred in a certain zone or location of interest by a person. As such, it is often impossible for the current approaches to intelligently determine if a certain protocol or procedure has been complied with or violated. Such protocol compliance is especially important for workplace environment like factories and offices where many safety protocols or operational procedure have to be followed to ensure efficiency operations in compliance with required regulations. Almost always, these safety or operational protocols encompass a collection of events/activities that need to occur in a specific order in a particular zone of interest as well as to be executed by a specific person, which is a non-trivial task when insufficient input parameters/context are available.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support workplace protocol compliance tracking in accordance with some embodiments.

FIG. 2 depicts an example of how user information is transmitted in accordance with some embodiments.

FIG. 3 depicts an example of a dashboard generated and provided to a user to track key events and analyze statistics about whether a set of protocols are being followed or violated in accordance with some embodiments.

FIGS. 4A-4D depict examples of various use cases where protocol compliance is required for employers to track employee safety to meet certain protocols in accordance with some embodiments.

FIGS. 5A-5D depict examples of various use cases where protocol compliance is enforced to ensure that employees are following production procedures to adhere to operational efficiency requirement in accordance with some embodiments.

FIG. 6 depicts a flowchart of an example of a process to support workplace protocol compliance tracking in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support protocol compliance by a person in various workplace applications and environments. Specifically, the proposed approach determines if a person is following a set of protocols/procedures created and defined to ensure safety and efficiency of the workers/employees in his/her workplace environment. This proposed approach focuses on specifying one or more zones of interest, identifying presence of the person and/or an object associated with the person in the one or more zones of interest, classifying a sequence of activities and/or postures of the person, and determining the durations of the activities. A user (e.g., an employer) is notified if it is determined that the person is not in compliance with the set of protocols in the workplace environment. In addition, data collected from the one or more zones of interest is stored securely in a local site to protect confidentiality of production processes as well as privacy of the person at the workplace.

The proposed approach has many applications in workplace environments (e.g., factories, offices, and retail stores) where strict compliance with a set of pre-determined or regulated set of protocols/procedures is critical for health/safety of the workers, operational efficiency of the businesses, and/or warehouse inventory control and theft prevention. For example, for the safety and health of the workers, the following activities of a person need to be monitored, documented or reported for protocol compliance in certain workplace environments: use of personal protection equipment (PPE), falls and dangerous activities, non-compliance in dangerous zones or equipment areas, non-compliance with maintenance protocols such as lock-out tag-out (LOTO) or chemical/gases change, lone worker monitoring, etc. Similarly, the following may also be tracked, documented, or reported for protocol compliance to ensure that a worker's operation efficiency is optimized in conjunction with equipment processes: if a worker performs required procedures at various stages of production, the time or durations when the worker is idle vs productive, if the worker is performing a set of procedures optimally, or if retraining is needed, the worker's response time/action to an equipment. For inventory theft control, the proposed approach can detect if an unauthorized person is in a designated area during off-hours or violating protocols by removing certain inventory.

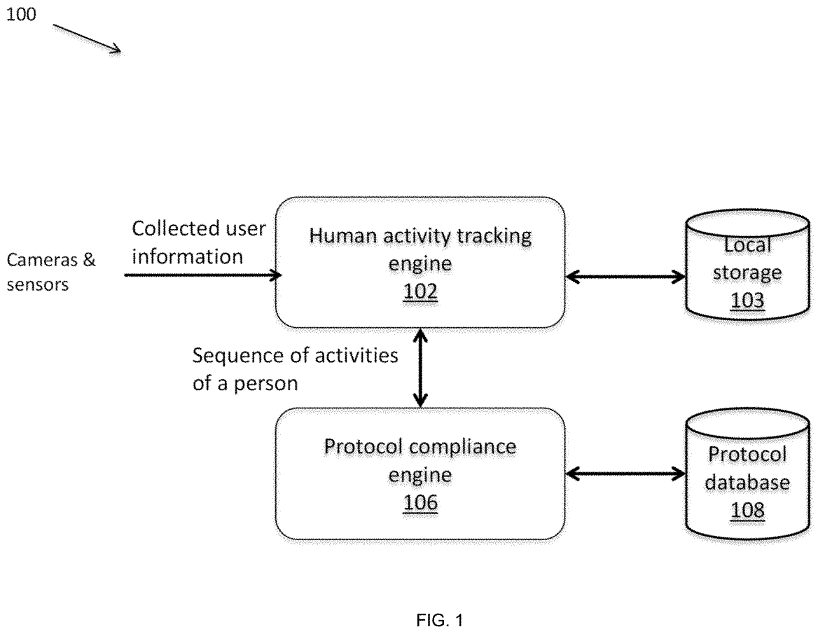

FIG. 1 depicts an example of a system diagram 100 to support workplace protocol compliance tracking. Although the diagram depicts components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more of a human activity tracking engine 102, a secured local storage 103, a protocol compliance engine 106, and a protocol database 108. These components in the system 100 each runs on one or more computing units/appliances/devices/hosts (not shown) each having one or more processors and software instructions stored in a storage unit such as a non-volatile memory (also referred to as secondary memory) of the computing unit for practicing one or more processes. When the software instructions are executed by the one or more processors, at least a subset of the software instructions is loaded into memory (also referred to as primary memory) by one of the computing units, which becomes a special purpose one for practicing the processes. The processes may also be at least partially embodied in the computing units into which computer program code is loaded and/or executed, such that the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google's Android device, an iPhone, an iPad, and a voice-controlled speaker or controller. Each computing unit has a communication interface (not shown), which enables the computing units to communicate with each other, the user, and other devices over one or more communication networks following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skilled in the art.

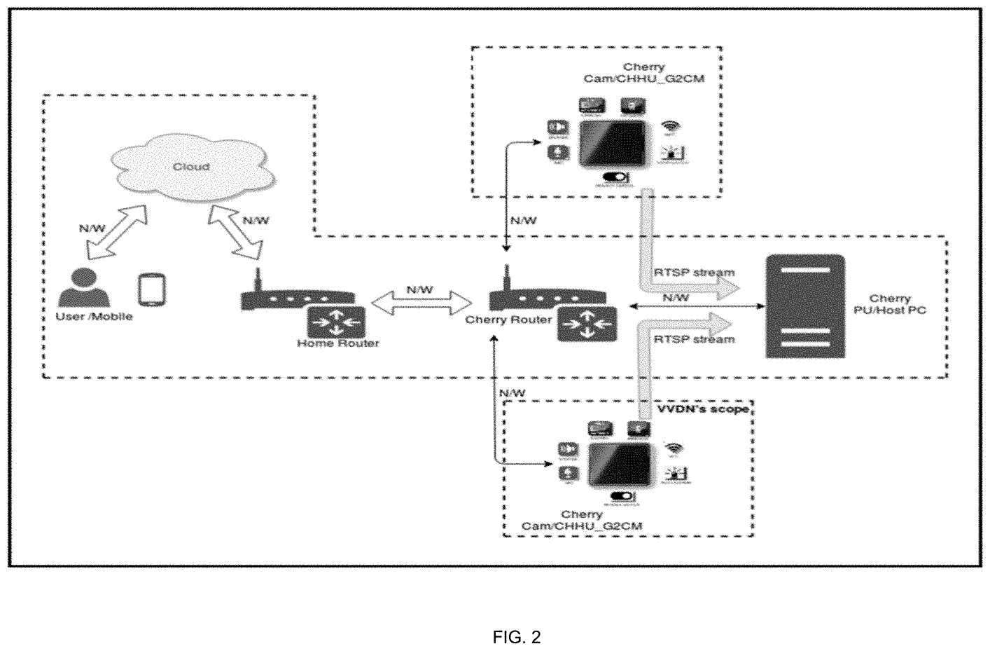

In the example of FIG. 1, the human activity tracking engine 102 is configured to accept information of a person under surveillance including video, audio streams and other data of the person collected by one or more cameras, audio input devices (e.g., microphones), and/or sensors at a monitored location (e.g., one or more zones of interest) and transmitted to the human activity tracking engine 102 via wireless or ethernet connection under a communication protocol. In some embodiments, the communication protocol is Real Time Streaming Protocol (RTSP), which is a network control protocol designed for use to control streaming media. In some embodiments, the information of the person collected at the zones of interest is accepted by the human activity tracking engine 102 for further analysis, which includes but is not limited to body images, postures and/or activities of the person, and the durations of the activities. FIG. 2 depicts an example of how the information of the person is transmitted to the human activity tracking engine 102 via, for non-limiting examples, wireless or ethernet connections through routers, networks and/or cloud.

In some embodiments, the human activity tracking engine 102 is configured to maintain the collected information (e.g., images, video, and/or audio) of the person in a secured local storage 103, which can be a data cache associated with the human activity tracking engine 102, to ensure data privacy and security of the person. In some embodiments, the data locally maintained in the secured local storage 103 can be accessed by the human activity tracking engine 102 and/or protocol compliance engine 106 via an Application Programming Interface (API) only under strict data access control policies (e.g., only accessible for authorized personnel or devices only) to protect the person's privacy. In some embodiments, information retrieved from the secured local storage 103 is encrypted before such information is transmitted over a network for processing or being accessed by an authorized application or a web-based service. In some embodiments, the secured local storage 103 resides onsite behind a user's firewall. Note that none of the sensitive video/audio of the person leaves the secured local storage 103 hence guaranteeing the person being monitored at the location/zone of interest has full control of his/her data, which is particularly important in highly confidential manufacturing or work areas as well as sensitive/private hospital or healthcare environment.

In some embodiments, the human activity tracking engine 102 is configured to track and identify the sequence of activities executed by the person or an object at the one or more zones/locations of interest executed for a certain amount of time. Here, the zones of interest are a pre-defined/prescribed space or area where the set of protocols must be complied with. In some embodiments, the human activity tracking engine 102 is configured to systematically define/mark out the zones of interest such that if an activity, a person, or an object is detected in the zones of interest by the human activity tracking engine 102, a series of actions will be triggered to ascertain whether the set of protocols for the zones of interest is enforced. In some embodiments, the human activity tracking engine 102 is configured to detect the presence of a person or an object on, associated with, or around the person at the zone of interest subject to the set of protocol in order to determine if compliance of the set of protocols is maintained. In some embodiments, the human activity tracking engine 102 is configured to track and/or record the amount of time the person spent in the zone of interest or doing certain activities in order to ascertain the person's compliance with the set of protocols.

Once the sequence of activities of the person at the one or more zones of interest has been detected, the sequence of activities of the person is provided to the protocol compliance engine 106, which is configured to determine if the sequence of activities of the person at the zone of interest follows the set of protocols or not. In some embodiments, the protocol compliance engine 106 is configured to create/define/describe the set of protocols to be enforced by a user (e.g., an employer, a production/safety manager, etc.) that needs to be complied by the person (e.g., an employee, a factory operator, etc.). Here, the set of protocols cover one or more of the one or more zones of interest, the presence of the person in the one or more zones of interest, the sequence of activities by the person or the object in the one or more zones of interest, and the duration of the sequence of activities. In some embodiments, the protocol compliance engine 106 is configured to create and enforce a set of protocols that are mandatory in a workplace environment to ensure worker safety, wherein such set of protocols includes one or more of the following:
Lock out and Tag out (LOTO) of electrical system before equipment maintenance;
COVID regulations (e.g., body temperature check, hand sanitizing, face mask);
Lone worker situation or buddy system enforcement;
(Un)safe working environment, including detection of dangerous objects, e.g., forklift, pallet jacks, danger zones, e.g., high temperature, heavy object risk, corrosion chemicals/gases, etc.;
Enforcement of personal protection equipment (PPE);
Warehouse inventory control and theft prevention.

In some embodiments, the protocol compliance engine 106 is configured to create and enforce a set of protocols for operational efficiency at a workplace, wherein such set of protocols includes one or more of the following:
Equipment maintenance checks (electrical grounding, leaks/spills inspection, corrosion detection, preventive maintenance checklist etc.);
Compliance with production procedures (product assembly, operating equipment, respond to equipment idle states, material handling etc.);
Unproductive working behaviors, e.g., idling, using phones, not in work zones etc.;
Proper housekeeping in the workplace (e.g., factory or office) spaces;
Following security protocols in the workplace (e.g., office lobby, production factory, etc.).

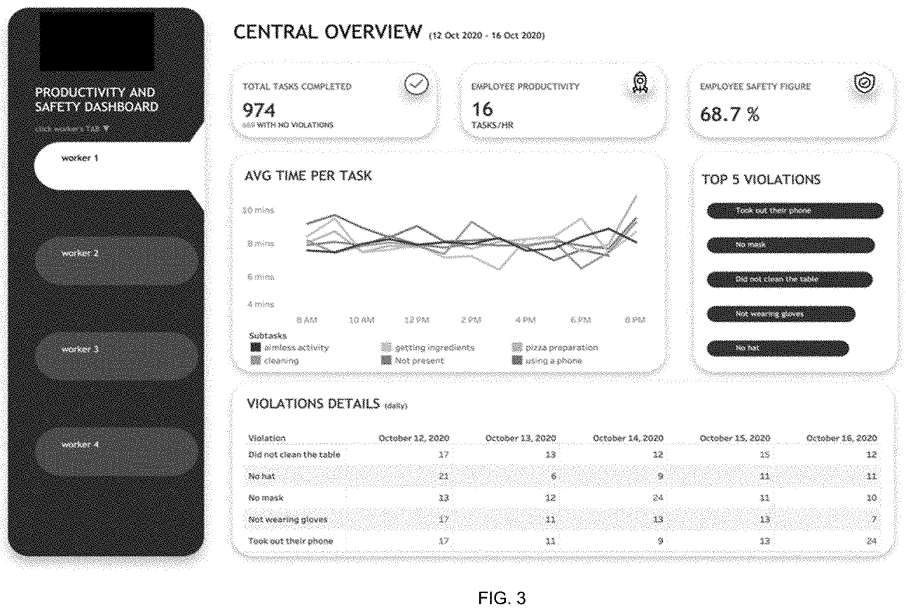

When a non-compliance event has been identified, the protocol compliance engine 106 is configured to trigger one or more notification/escalation procedures to document and report the non-compliance event to a user per agreement with the user. For example, the protocol compliance engine 106 is configured to provide one or more of an email/text message notification or a phone call to the manager-in-charge, a notification in the user portal monitored by a designated employee, and an alert to a smart mobile device. In some embodiments, the protocol compliance engine 106 is configured to report the violation to the user in the form of a dashboard in order for the user to analyze and correct/recover the situation. FIG. 3 shows an example of a dashboard generated and provided to the user (e.g., the employer) to track key events and analyze statistics about whether the set of protocols are being followed or violated, wherein such statistics includes but is not limited to total tasks completed, average time per task, employee productivity and safety figures, top violations, etc. These statistics enables the user to determine if a worker need any training specific to a particular safety or operations protocols if the worker did not meet the expected success requirement. As shown by the example of FIG. 3, the dashboard provides daily, weekly, monthly, quarterly, yearly summary of key performance index (KPI) that will help steer the employer towards a safety protocol or operations efficiency goal which will directly impact the company's bottom line.

In some embodiments, the protocol compliance engine 106 is configured to accept input from an existing alarm system (e.g., Andon lights, Sound alarms etc.) to identify/classify an escalation event when a safety compliance protocol or an operation procedure is being violated. This will reinforce any escalation protocols (emails, phone calls etc.) to the designated person-in-charge to correct/recover the situation. In some embodiments, the protocol compliance engine 106 is configured to utilize/trigger any existing alarm system (e.g., sound or light) in the affected work environment to notify the person of a violation event in order to minimize the risk to the person and/or other affected/surrounding person(s), e.g., a forklift out of control in a work zone or a chemical spill due to non-compliance of maintenance protocols.

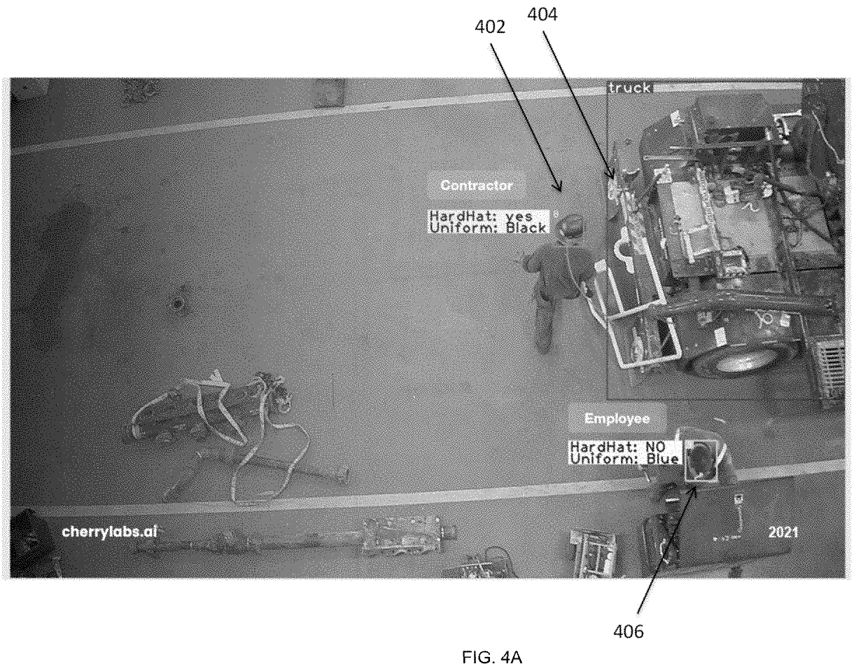

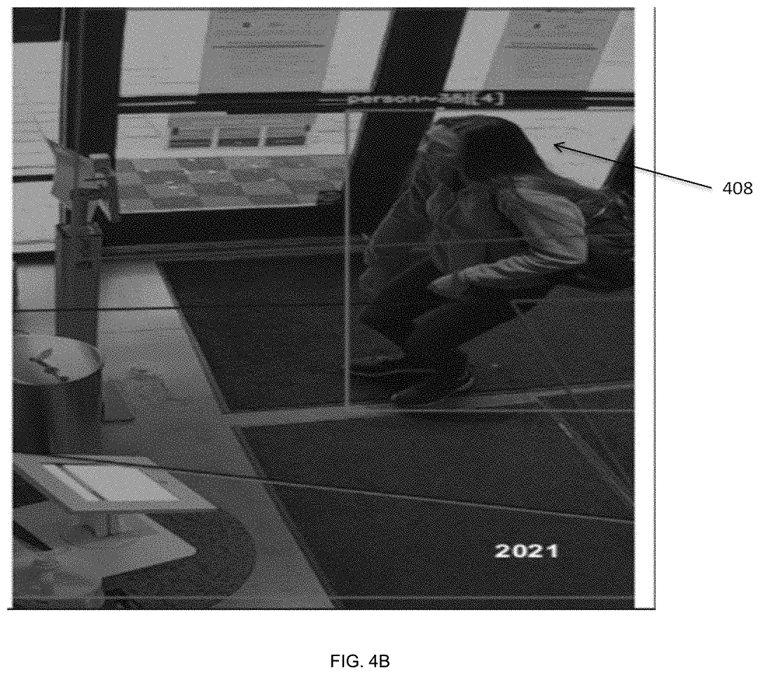

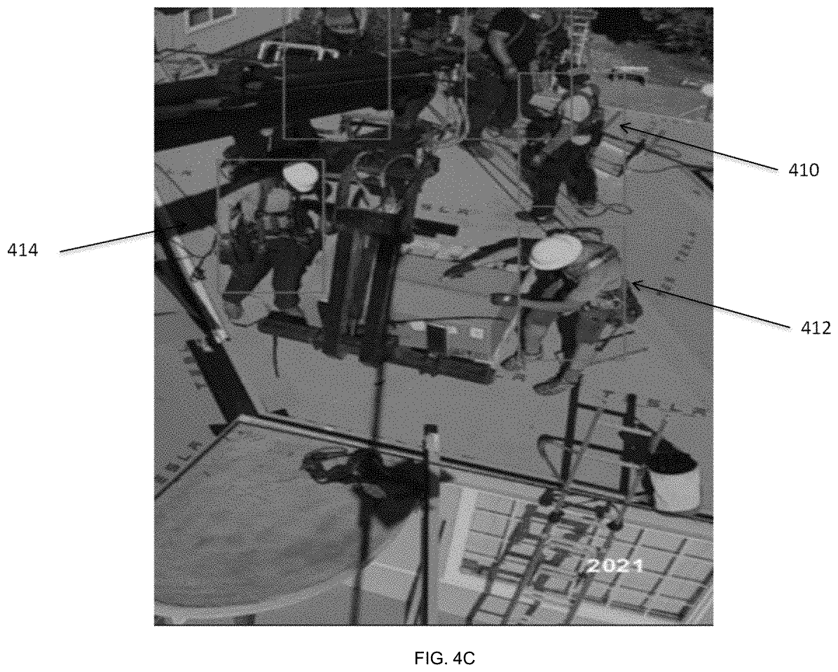

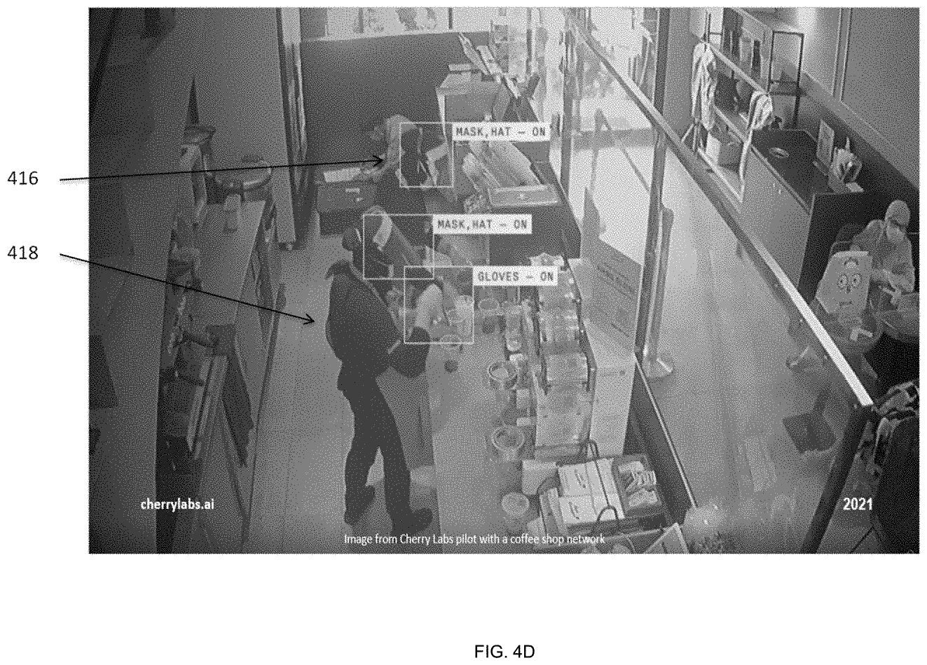

FIGS. 4A-4D depict examples of various use cases where protocol compliance is required for employers to track employee safety to meet certain protocols such as Environmental, Health, and Safety (EHS) protocols and/or Health Service Executive (HSE) protocols. and inform if the workers are in a danger zone (behind a truck). FIG. 4A shows examples of identification of violations of a safety protocol where presence of a person 402 in black uniform is detected and recognized as an unauthorized contractor in a predetermined danger zone behind a high-risk object 404, e.g., a truck. Moreover, the posture of the contractor indicates that a dangerous situation is apparent because he might not be visible to the truck driver. Another employee 406 in blue uniform is also in violation because he does not wear a hardhat. FIG. 4B shows an example of how the system 100 is configured to track and determine if COVID regulations are followed by an employee 408 in a workplace environment, e.g., if the person 408 is wearing mask or having body temperature measured. FIG. 4C demonstrates an example where the human activity tracking engine 102 is configured to identify if the workers 410, 412, and 414 are wearing safety harnesses in the designed danger zones on a rooftop. FIG. 4D shows an example of monitoring whether employees 416 and 418 in a retail store are following food safety compliance by wearing proper masks and gloves.

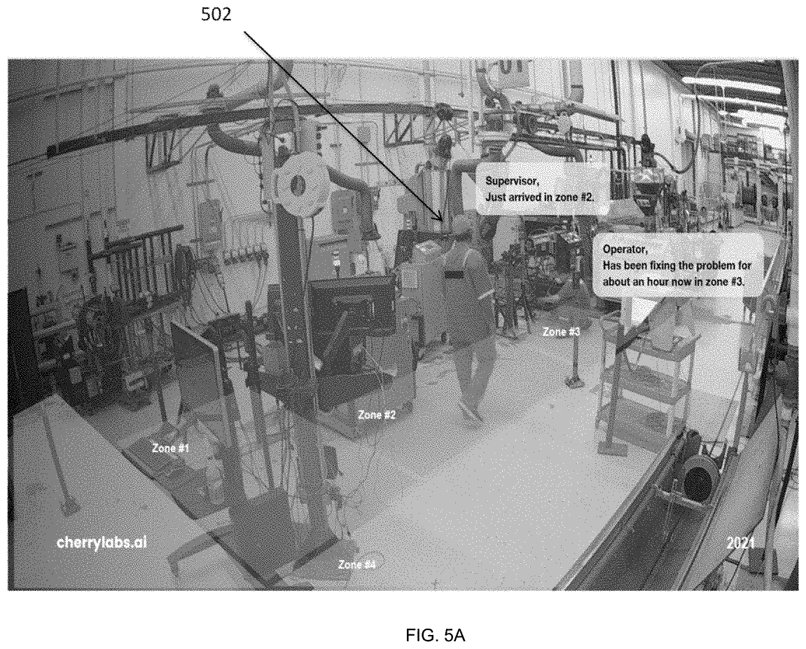

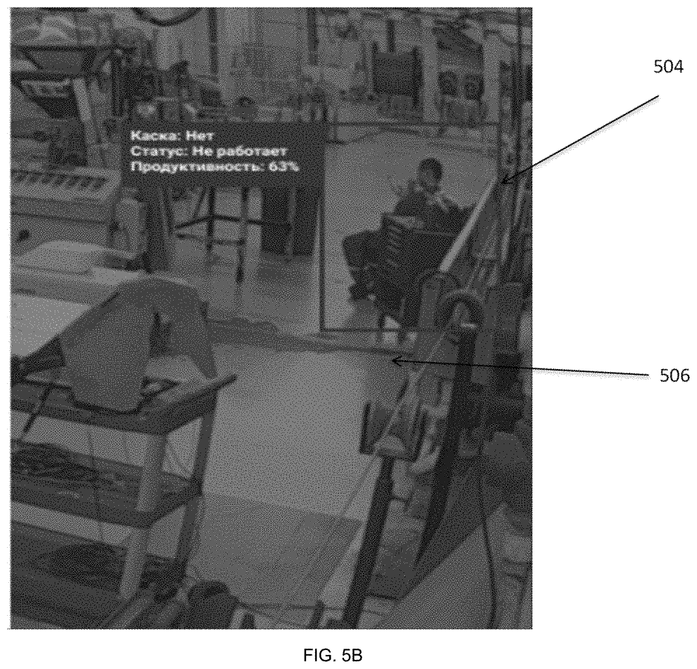

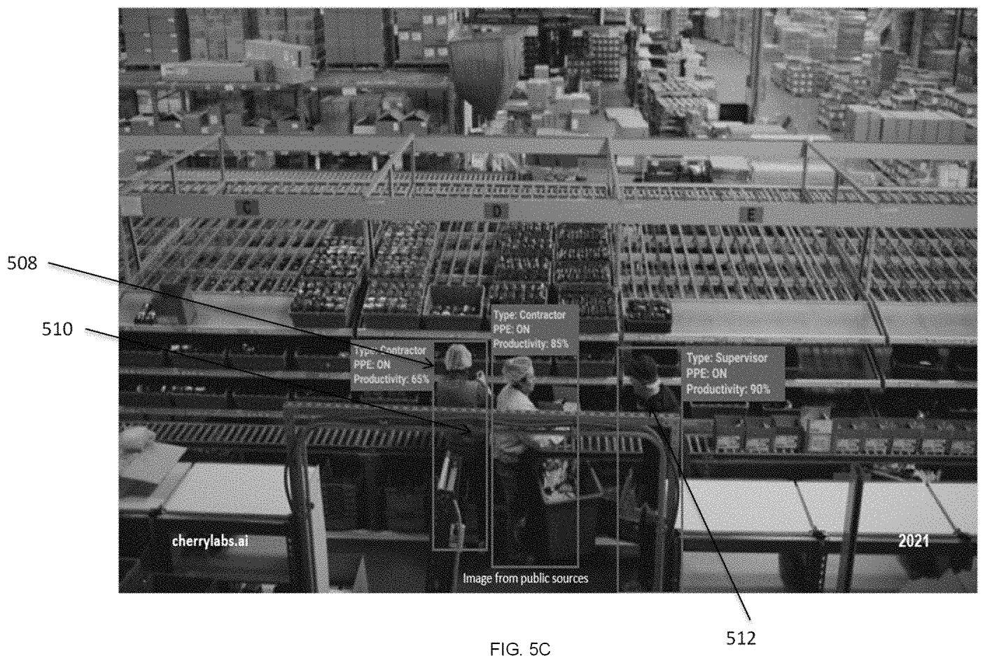

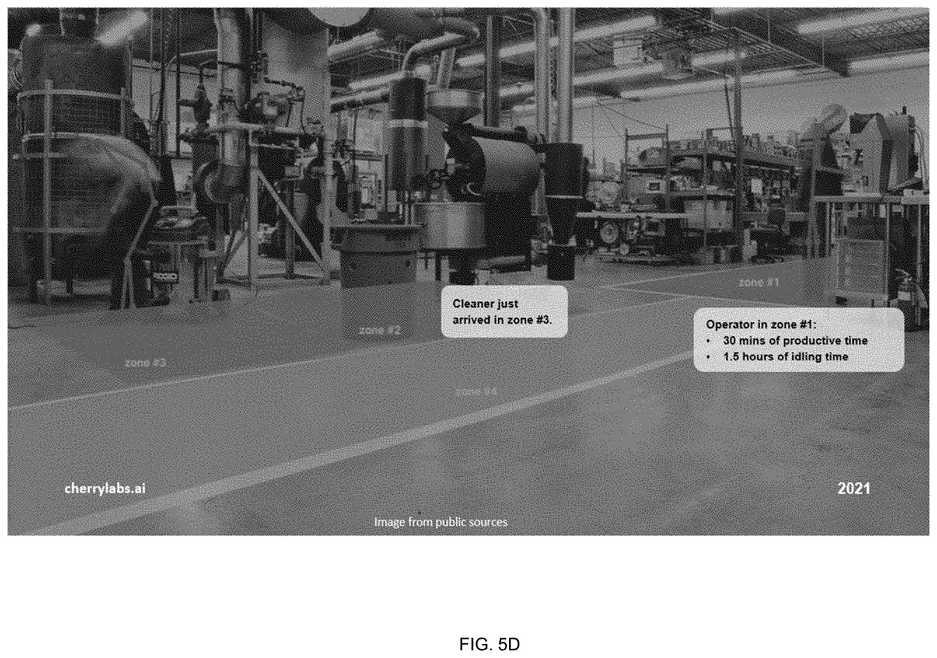

FIGS. 5A-5D depict examples of various use cases where protocol compliance in enforced to ensure that employees are following production procedures to adhere to operational efficiency requirement. FIG. 5A shows an example of a typical factory environment where multiple zones of interest, e.g., Zone #1 to #4, are defined for compliance with a set of protocols for the factory environment. Worker/operator 502 is working in the zones of the interest and his presence, postures/activities, and the duration of his activities are monitored and tracked by the system 100 in order to determine that worker 502 follows the set of protocols for the factory environment. During his work (e.g., response to an equipment in an idle state), worker 502 keeps communication with an operator and any deviation from the set of protocols (e.g., takes longer than the protocol) will trigger an alert of non-compliance to his supervisor. The ability to monitor and analyze if operation procedures are being followed by the employees in real time directly affects factory efficiency and proper training of workers, which will inevitably result in cost-savings in the factory bottom-line costs. FIG. 5B demonstrates an example the human activity tracking engine 102 detecting presence of a person 504 in a certain work zone 506 where the posture of the person is classified as non-productive or safety violation or idle time in the workplace environment and the person 504's supervisor is being notified. FIG. 5C shows an example of how the system 100 is utilized to ensure that the product assembly procedure in a factory is not violated in order to maximize yield and output. In this example, the proper protection status (e.g., PPE) and the productivity of both the contractors 508 and 510 and their supervisor 512 are monitored, identified, documented, and reported. FIG. 5D demonstrates an example of how the system 100 can enable an employer to improve operation efficiency by tracking idle vs productive time of a person (e.g., an operator) in zone #1 and if a designated personnel (e.g., a cleaner) is in the allowed work area (e.g., zone #3).

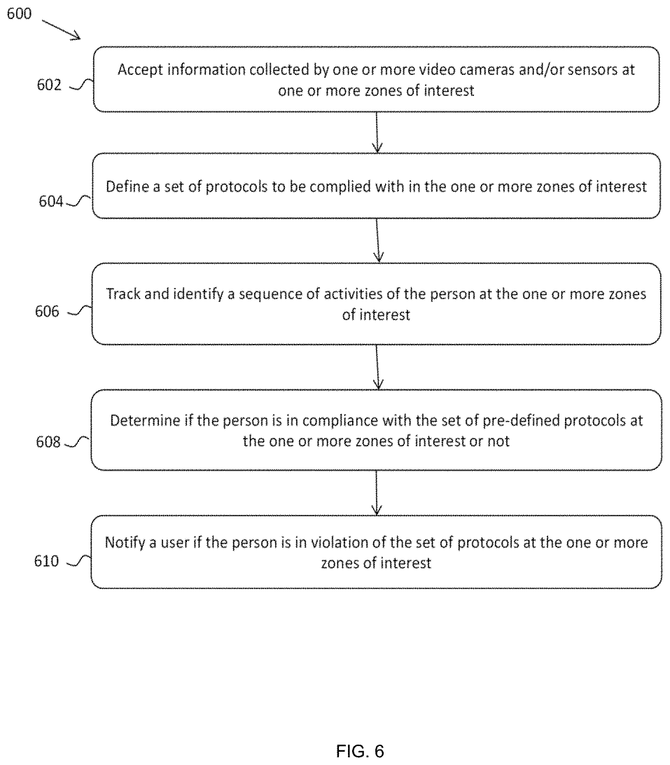

FIG. 6 depicts a flowchart 600 of an example of a process to support workplace protocol compliance tracking. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 6, the flowchart 600 starts at block 602, where information collected by one or more video cameras and/or sensors at one or more zones of interest is accepted. The flowchart 600 continues to block 604, where a set of protocols to be complied with in the one or more zones of interest is defined. The flowchart 600 continues to block 606, where a sequence of activities of the person at the one or more zones of interest is tracked and identified. The flowchart 600 continues to block 608, where it is determined whether the person is in compliance with the set of pre-defined protocols at the one or more zones of interest or not. The flowchart 600 ends at block 610, where a user is notified if the person is in violation of the set of protocols at the one or more zones of interest.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system to support workplace protocol compliance tracking, comprising:
a human activity tracking engine configured to
accept information of a person collected by one or more of a video camera, an audio input device, and one or more sensors at one or more zones of interest;
track and identify a sequence of activities of the person at the one or more zones of interest;
a protocol compliance engine configured to
define a set of protocols to be complied with in the one or more zones of interest;
determine if the person is in compliance with the set of protocols at the one or more zones of interest or not;
notify a user if the person is in violation of the set of protocols at the one or more zones of interest.

2. The system of claim 1, wherein:
each of the one or more zones of interest is a factory area, an office space, or a designated area.

3. The system of claim 1, further comprising:
a secured local storage configured to securely maintain the collected information of the person at the one or more zones of interest, wherein the secured local storage is accessible under data access control policies.

4. The system of claim 1, wherein:
the human activity tracking engine is configured to detect presence of the person or an object associated with the person at the one or more zones of interest from the collected information.

5. The system of claim 1, wherein:
the human activity tracking engine is configured to track and/or record an amount of time the person spent in the one or more zones of interest or doing certain activities in order to ascertain the person's compliance with the set of protocols.

6. The system of claim 1, wherein:
the set of protocols cover one or more of: the one or more zones of interest, presence of the person in the one or more zones of interest, the sequence of activities by the person or an object in the one or more zones of interest, and duration of the sequence of activities.

7. The system of claim 1, wherein:
the protocol compliance engine is configured to enforce the set of protocols that are mandatory in a workplace environment to ensure worker safety.

8. The system of claim 1, wherein:
the protocol compliance engine is configured to enforce the set of protocols for operational efficiency at a workplace environment.

9. The system of claim 1, wherein:
the protocol compliance engine is configured to detect non-compliance of the person due to unauthorized removal of a product or an inventory in a work environment.

10. The system of claim 1, wherein:
the protocol compliance engine is configured to provide one or more of a notification or a phone call to the manager-in-charge, a notification in the user portal monitored by a designated employee, and an alert to a smart mobile device if the person is in violation of the set of protocols at the one or more zones of interest.

11. The system of claim 1, wherein:
the protocol compliance engine is configured to report to the user in form of a dashboard in order for the user to track key events and analyze statistics about whether the set of protocols are being followed or violated.

12. The system of claim 1, wherein:
the protocol compliance engine is configured to alert the person directly that his/her activities are not in compliance with the set of protocols and need to be corrected if the person is in violation of the set of protocols at the one or more zones of interest.

13. The system of claim 12, wherein:
the protocol compliance engine is configured to utilize an existing alarm system to notify the person of a violation event in order to minimize the risk to the person and/or other affected/surrounding person.

14. The system of claim 1, wherein:
the protocol compliance engine is configured to accept input from an existing alarm system to identify an escalation event when the set of pre-defined protocols is being violated.

15. A method to support workplace protocol compliance tracking, comprising:
accepting information of a person collected by one or more of a video camera, an audio input device, and one or more sensors at one or more zones of interest;
defining a set of protocols to be complied with in the one or more zones of interest;
tracking and identifying a sequence of activities of the person at the one or more zones of interest;
determining if the person is in compliance with the set of protocols at the one or more zones of interest or not;
notifying a user if the person is in violation of the set of protocols at the one or more zones of interest.

16. The method of claim 15, further comprising:
securely maintaining the collected information of the person at the one or more zones of interest on a secured local storage, wherein the secured local storage is accessible under data access control policies.

17. The method of claim 15, further comprising:
detecting the presence of the person or an object associated with the person at the one or more zones of interest from the collected information.

18. The method of claim 15, further comprising:
tracking and/or recording an amount of time the person spent in the one or more zones of interest or doing certain activities in order to ascertain the person's compliance with the set of protocols.

19. The method of claim 15, further comprising:
enforcing the set of protocols that are mandatory in a workplace environment to ensure worker safety.

20. The method of claim 15, further comprising:
enforcing the set of protocols for operational efficiency at a workplace environment.

21. The method of claim 15, further comprising:
detecting non-compliance of the person due to unauthorized removal of a product or an inventory in a work environment.

22. The method of claim 15, further comprising:
providing one or more of a notification or a phone call to the manager-in-charge, a notification in the user portal monitored by a designated employee, and an alert to a smart mobile device if the person is in violation of the set of protocols at the one or more zones of interest.

23. The method of claim 15, further comprising:
reporting to the user in form of a dashboard in order for the user to track key events and analyze statistics about whether the set of protocols are being followed or violated.

24. The method of claim 15, further comprising:
alerting the person directly that his/her activities are not in compliance with the set of protocols and need to be corrected if the person is in violation of the set of protocols at the one or more zones of interest.

25. The method of claim 24, further comprising:
utilizing an existing alarm system to notify the person of a violation event in order to minimize the risk to the person and/or other affected/surrounding person.

26. The method of claim 15, further comprising:
accepting input from an existing alarm system to identify an escalation event when the set of pre-defined protocols is being violated.
